(19) United States
(12) Patent Application Publication
(10) Pub. No.: US 2013/0258158 A1
(43) Pub. Date: Oct. 3, 2013

(54) ELECTRONIC DEVICE

(71) Applicant: PANASONIC CORPORATION, Osaka (JP)

(72) Inventor: YOSHITERU ADACHI, Hyogo (JP)

(73) Assignee: PANASONIC CORPORATION, Osaka (JP)

(21) Appl. No.: 13/658,966

(22) Filed: Oct. 24, 2012

(30) Foreign Application Priority Data
Mar. 28, 2012 (JP) 2012-074145

(51) Int. Cl. H04N 5/225

(52) U.S. Cl. 348/333.02; 348/E05.024

(57) ABSTRACT

The electronic device disclosed herein includes an image recognition component, an attribute recognition component, a scale setting component, a map setting component, and a map display component. The image recognition component is configured to recognize image data which is displayed on a display component. The attribute recognition component is configured to recognize attribute information. The attribute information is information which is related to a shooting situation. The attribute information is associated with the image data. The scale setting component is configured to set a scale of a map image on a basis of the attribute information. The map setting component is configured to set the map image so that the map image includes shooting position on a basis of map information which is recorded on a storage component. The attribute information includes the shooting position. The map display component displays the map image according to the above-mentioned scale.

### CROSS-REFERENCE TO RELATED APPLICATIONS

This application claims priority under 35 U.S.C. §119 to Japanese Patent Application No. 2012-074145 filed on Mar. 28, 2012. The entire disclosure of Japanese Patent Application No. 2012-074145 is hereby incorporated herein by reference.

### BACKGROUND

1. Technical Field

The present technology disclosed herein relates to an electronic device configured to change a scale of a map image including the shooting position, on a basis of attribute information about image data.

2. Background Information

Some digital cameras that have come out in recent years are capable of conveying the position where an image was captured, on a map displayed on the monitor. More specifically, a digital camera of this type has a built-in global positioning system (GPS). GPS allows the position (longitude and latitude) of the camera at the time of image capture to be specified. Specifically, the position where the image was captured can be specified with the GPS. For example, if a map button is pressed while a captured image is being displayed on the monitor, the shooting position acquired by GPS is displayed on a map in a fixed scale. As an example related to this technology, there is a camera which displays a plurality of thumbnail images at the various positions where the images were captured (see Japanese Laid-Open Patent Application 2008-204348).

As discussed above, with a conventional digital camera, the positions where images were captured are displayed in a fixed scale on a map. More specifically, with a conventional digital camera, a large, fixed scale is set so that scaled image positions will appear natural to the user in a variety of scenes, such as when a person is being photographed, or when a landscape is being photographed. In this case, however, the user has to change the scale of the map every time in order to obtain the desired information from a map that includes the shooting position.

The present technology was conceived in light of this problem, and the present technology provides an electronic device with which it is easier for the user to acquire position information.

### SUMMARY

The electronic device disclosed herein comprises an image recognition component, an attribute recognition component, a scale setting component, a map setting component, and a map display component. The image recognition component is configured to recognize image data displayed on a display component. The attribute recognition component is configured to recognize attribute information. The attribute information is information related to a shooting situation. The attribute information is associated with the image data recognized by the image recognition component. The scale setting component is configured to set a scale of a map image on a basis of the attribute information recognized by the attribute recognition component. The map setting component is configured to set the map image so that the map image includes a shooting position on a basis of map information recorded on a storage component. The attribute information includes the shooting position. The map display component is configured to display the map image including the shooting position according to the scale set by the scale setting component.

With the present technology, ease of operation is improved when a user acquires position information.

### BRIEF DESCRIPTION OF THE DRAWINGS

Referring now to the attached drawings, which form a part of this original disclosure:

FIG. 1 is a front view of a digital camera pertaining to an embodiment;

FIG. 2 is a rear view of the digital camera pertaining to this embodiment;

FIG. 3 is a control block diagram of the digital camera pertaining to this embodiment;

FIG. 4 is a flowchart showing the flow of processing in the digital camera pertaining to this embodiment;

FIG. 5A is a schematic diagram of a shooting situation with the digital camera pertaining to this embodiment (when a distant view is captured);

FIG. 5B is a diagram of a map image displayed on a liquid crystal monitor with the digital camera pertaining to this embodiment (when a distant view is captured and orientation information is taken into account);

FIG. 6A is a schematic diagram of a shooting situation with the digital camera pertaining to this embodiment (when a close-up view is captured);

FIG. 6B is a diagram of a map image displayed on a liquid crystal monitor with the digital camera pertaining to this embodiment (when a close-up view is captured and orientation information is taken into account);

FIG. 7A is a schematic diagram of a shooting situation with the digital camera pertaining to this embodiment (when a distant view is captured); and

FIG. 7B is a diagram of a map image displayed on a liquid crystal monitor with the digital camera pertaining to this embodiment (when a distant view is captured).

### DETAILED DESCRIPTION OF EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

### 1. Configuration of Digital Camera

The configuration of a digital camera 100 will now be described through reference to the drawings.

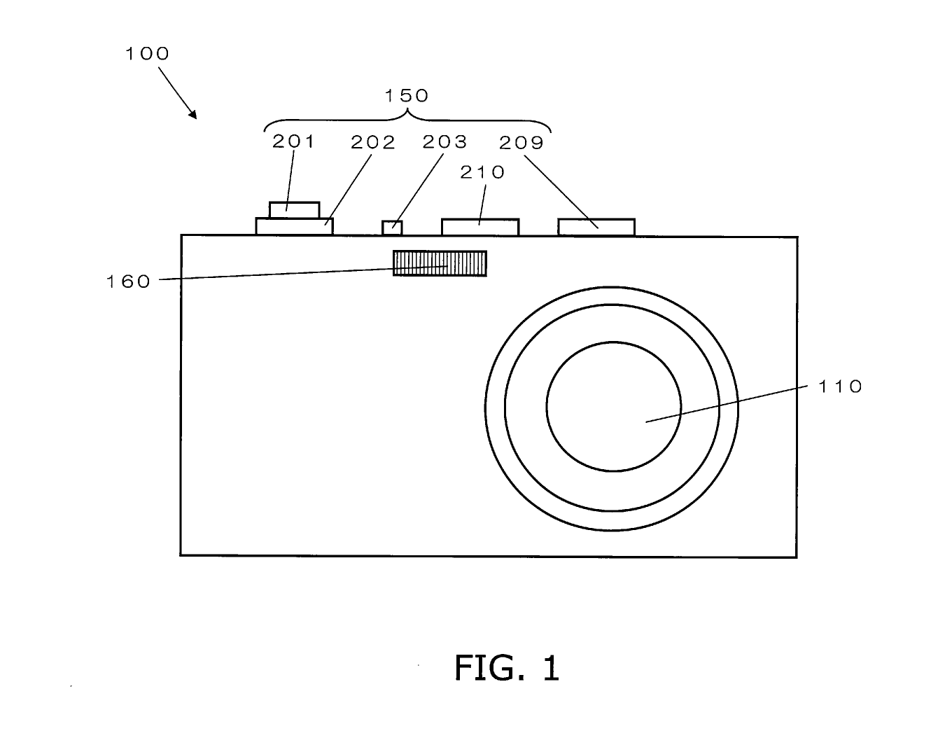

FIG. 1 is a front view of the configuration of the digital camera 100. The front face of the digital camera 100 is equipped with a lens barrel that houses an optical system 110. Also, the digital camera 100 comprises controls such as a zoom lever 202 and a power button 203.

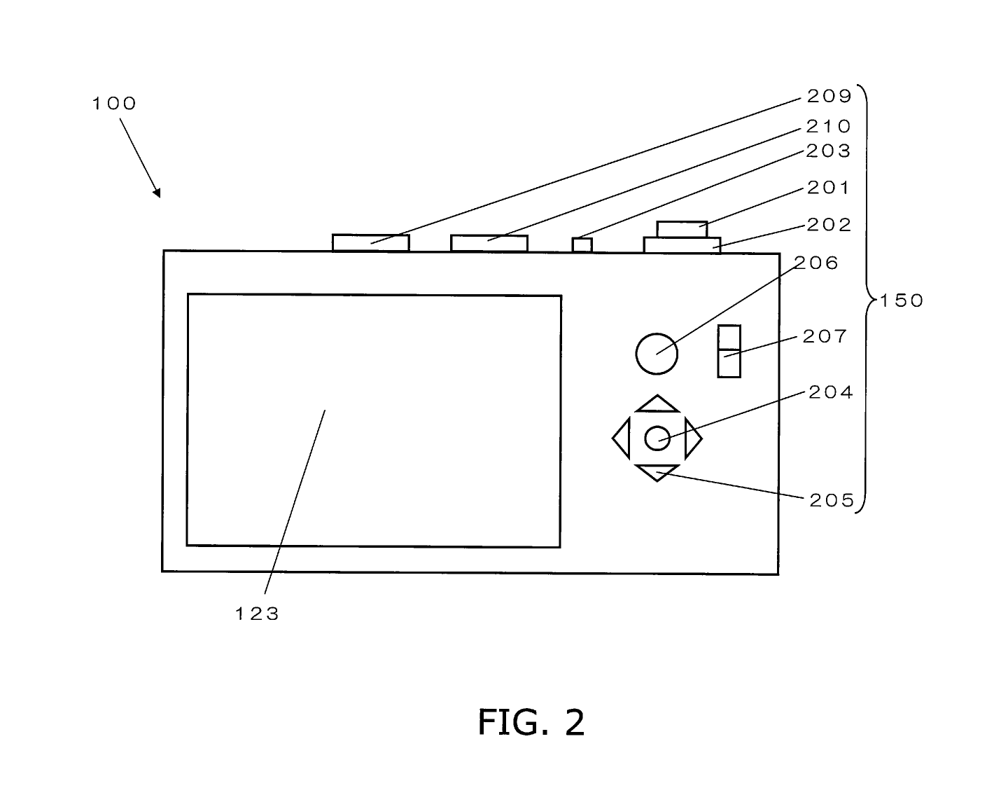

FIG. 2 is a rear view of the configuration of the digital camera 100. The rear face of the digital camera 100 is equipped with a liquid crystal monitor 123, control buttons, and so forth. The control buttons include a set button 204, directional buttons 205, a map button 206, a mode switch 207, and so forth.

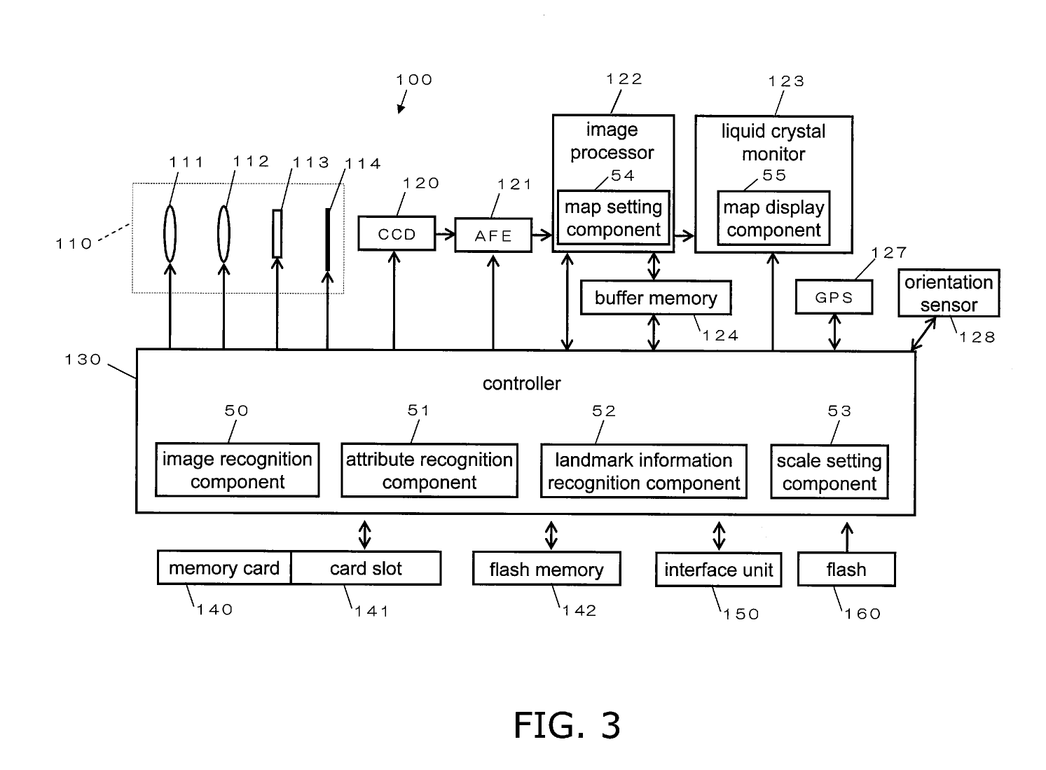

FIG. 3 is a control block diagram of the digital camera 100. The digital camera 100 uses a CCD image sensor 120 to capture a subject image formed via the optical system 110. The CCD image sensor 120 products image information on the basis of the captured subject image. The image information produced by this imaging is subjected to various kinds of processing by an AFE (analog front end) 121 and an image processor 122. The image information thus produced is recorded to a flash memory 142 or a memory card 140. The image information recorded to the flash memory 142 or the memory card 140 is displayed on the liquid crystal monitor 123 by operation of an interface component 150 by the user.

The various components will now be described in detail through reference to FIGS. 1 to 3.

The optical system 110 is made up of a focus lens 111, a zoom lens 112, an aperture 113, a shutter 114, and so forth. Although not depicted, the optical system 110 may include an optical shake correction lens OIS (optical image stabilizer). The lenses that make up the optical system 110 may be made up of a number of lenses, or may be made up of a number of groups.

The focus lens 111 is used to adjust the focal state of a subject. The zoom lens 112 is used to adjust the image angle of a subject. The aperture 113 is used to adjust the amount of light incident on the CCD image sensor 120. The shutter 114 adjusts the exposure time for light incident on the CCD image sensor 120. The focus lens 111, the zoom lens 112, the aperture 113, and the shutter 114 are each driven by their own drive means, such as a DC motor or a stepping motor, according to control signals sent from a controller 130.

The CCD image sensor 120 produces image information by capturing a subject image formed by the optical system 110. The CCD image sensor 120 can produce a new frame of image information for each specific unit of time when the digital camera 100 is in imaging mode.

With the AFE 121, the image information read from the CCD image sensor 120 is subjected to noise suppression by correlated double sampling, to amplification to the input range width of an A/D converter by an analog gain controller 130, to A/D conversion by an A/D converter, and so on. After this, the AFE 121 outputs the image information to the image processor 122.

The image processor 122 performs various kinds of processing on the image information outputted from the AFE 121. Examples of this processing include smear correction, white balance correction, gamma correction, YC conversion processing, electronic zoom processing, extraction processing, compression processing, and expansion processing, but this list is not intended to be comprehensive. The extraction processing referred to here corresponds to processing in which all or part of the image information read from the CCD image sensor is cut out (extracted). The cutting range here is decided according to the aspect ratio of the image information (moving or still picture) to be recorded. Information related to the aspect ratio of the image information to be recorded is recorded to the flash memory 142. The image processor 122 stores the image information that has undergone the various kinds of processing in a buffer memory 124. The image processor 122 may be constituted by a hard-wired electronic circuit, or may be constituted by a microprocessor or the like in which a program is used. It may also be constituted by a single semiconductor chip along with the controller 130, etc.

The liquid crystal monitor 123 is provided to the rear face of the digital camera 100. The liquid crystal monitor 123 displays an image based on the image information processed by the image processor 122. Images displayed on the liquid crystal monitor 123 include through-images and recorded images. A through-image is one in which images for new frames produced by the CCD image sensor 120 at specific time intervals are continuously displayed. Usually, when the digital camera 100 is in imaging mode, the image processor 122 produces a through-image from the image information produced by the CCD image sensor 120. The user can capture a subject image while checking on the composition of the image by referring to the through-image displayed on the liquid crystal monitor 123. A recorded image is one in which a high-resolution image recorded to the memory card 140, etc., is reduced to a low resolution in order to be displayed on the liquid crystal monitor 123 when the digital camera 100 is in reproduction mode. The high-resolution image information recorded to the memory card 140 is produced by the image processor 122 on the basis of the image information produced by the CCD image sensor 120 when the controller 130 has detected input through the shutter button or the moving picture capture button.

The controller 130 performs overall control over the operation of the entire digital camera 100. The controller 130 also records image information stored in the buffer memory 124 (after being processed by the image processor 122) to the memory card 140 or another such recording medium. The controller 130 is constituted by a CPU or the like that processes various kinds of information by executing a program, or a ROM that holds programs and other such information. The ROM holds programs for overall control of the entire digital camera 100, as well as for file control, auto-focus control (AF control), and auto-exposure control (AE control).

The controller 130 may be constituted by a hard-wired electronic circuit, or may be constituted by a microprocessor or the like. It may also be constituted by a single semiconductor chip along with the image processor 122, etc. Also, the ROM need not be built into the interior of the controller 130, and may instead be provided outside of the controller 130.

The buffer memory 124 is a memory means that functions as a working memory for the controller 130 and the image processor 122. The buffer memory 124 can be a DRAM (dynamic random access memory) or the like. Also, the flash memory 142 functions as an internal memory for recording image information, setting information, and so forth.

The card slot 141 is a connection means that allows the memory card 140 to be inserted and removed. The card slot 141 allows the memory card 140 to be electrically and mechanically connected. The card slot 141 may also have the function of controlling the memory card 140.

The memory card 140 is an external memory equipped with an internal flash memory or other such recording component. The memory card 140 is able to record image information or other such data processed by the image processor 122.

A GPS 127 is global positioning system. The GPS 127 is used to calculate the position of the digital camera 100. For example, the GPS 127 acquires latitude information and longitude information about the digital camera 100. This latitude and longitude information is recorded to a recording medium (such as the memory card 140 and/or the flash memory 142), or to the buffer memory 124, or to both.

An orientation sensor 128 is used to calculate the direction of the subject, using the position of the digital camera 100 as a reference. For example, orientation information corresponding to the direction in which the digital camera 100 is facing the subject is calculated on the basis of data from the orientation sensor 128. This orientation information is recorded to a recording medium (such as the memory card 140 and/or the flash memory 142), or to the buffer memory 124, or to both.

The interface component 150 is the collective name for the interface buttons and dials provided to the outside of the digital camera 100 and operated by the user. For example, the interface component 150 has a shutter button 201, the map button 206, a zoom lever 202, the power button 203, the set button 204, the directional buttons 205, the mode switch 207, a moving picture capture button 210, and so forth, as shown in FIGS. 1 and 2. The shutter button 201 is a push button for recording still pictures. When it is detected that the user has pressed the shutter button 201, the controller 130 records the image information produced by the image processor 122, as a still picture, to a recording medium (such as the memory card 140 and/or the flash memory 142), or to the buffer memory 124, or to both, on the basis of the image information produced by the CCD image sensor 120. Here, the controller 130 produces attribute information, assigns it to the image information, and records this image information.

The map button 206 is operated by the user in reproduction mode, and conveys to the controller 130 a map display signal for displaying a map. Thereupon, the controller 130 performs control for displaying map-use image data on the liquid crystal monitor 123.

The zoom lever 202 is center-position self-returning lever used to adjust the image angle between the wide angle end and the telephoto end. When the zoom lever 202 is operated by the user in imaging mode, an operating instruction signal is sent to the controller 130 for driving the zoom lens 112. Specifically, when the zoom lever 202 is moved to the wide angle end side, the controller 130 drives the zoom lens 112 so that a subject is captured in wide angle. Similarly, when the zoom lever 202 is moved to the telephoto end side, the controller 130 drives the zoom lens 112 so that the subject is captured in telephoto.

Also, when the zoom lever 202 is operated while a map is being displayed in reproduction mode, a scale change signal for changing the scale of the map is sent to the controller 130. This changes the scale of the map displayed on the liquid crystal monitor 123. The power button 203 is a push button used for switching the power on and off to the various components constituting the digital camera 100. When the power button 203 is pressed by the user while the power is off, the controller 130 supplies power to the various components constituting the digital camera 100, and actuates them. When the power button 203 is pressed by the user while the power is on, the controller 130 stops the supply of power to the various components.

The set button 204 is a push button. When the user presses the set button 204 while the digital camera 100 is in imaging mode or reproduction mode, the controller 130 displays a menu screen on the liquid crystal monitor 123. The menu screen is used to set the various conditions for imaging and reproduction. Settings such as switching a shutter sound on or off are made on the menu screen. The information set on the menu screen is recorded to the flash memory 142. When the set button 204 is pressed while a setting category for one of the various conditions has been selected, the set button 204 also functions as an enter button.

The directional buttons 205 are push buttons provided in the up, down, left, and right directions. The user presses the directional buttons 205 in one of these directions to select one of the various condition categories displayed on the liquid crystal monitor 123.

The mode switch 207 is a push button provided in the up and down directions. The user presses either the upper or lower part of the mode switch 207 to switch the state of the digital camera 100 between imaging mode and reproduction mode.

The moving picture capture button 210 is a push button used to start or end the recording of a moving picture. When it is detected that the user has pressed the moving picture capture button, the controller 130 records the image information produced by the image processor 122, as a moving picture, to a recording medium (such as the memory card 140 and/or the flash memory 142), or to the buffer memory 124, or to both, on the basis of the image information produced by the CCD image sensor 120. Here, just as with a still picture, the controller 130 produces attribute information, assigns it to the image information, and records this image information. When the moving picture capture button 210 is pressed again, the recording of the moving picture ends.

The CCD image sensor 120 is an example of an imaging component. The cross key 205 are an example of an interface component. The controller 130 is an example of a control component. The controller 130 is also an example of a focus controller. The liquid crystal monitor 123 is an example of a display component. The memory card 140 and/or flash memory 142 or other such recording medium, and the buffer memory 124 are an example of a memory component.

### 2. Functions of Digital Camera

FIG. 3 is a control block diagram of the digital camera 100. The characteristic functions of this digital camera will be described through reference to FIG. 3.

The image recognition component 50 recognizes image information (including image data) displayed on the liquid crystal monitor 123 (an example of a display component). More specifically, the controller 130 recognizes image information recorded to a recording medium (such as the memory card 140 and/or the flash memory 142), or to the buffer memory 124, or to both.

The attribute recognition component 51 recognizes attribute information associated with image information (including image data). More specifically, the controller 130 recognizes attribute information associated with image data. This attribute information includes scene information (including mode data) related to a shooting scene (including imaging mode), position information (including longitude data and latitude data) acquired by the GPS 127, and orientation information (including orientation data) included in direction information. Scene information (including mode data) is information (data) for specifying the scene mode.

A landmark information recognition component 52 (an example of a landmark information recognition component) recognizes landmark information (including landmark data) recorded to a recording medium (such as the memory card 140 and/or the flash memory 142), or to the buffer memory 124, or to both. More specifically, the controller 130 reads landmark data from a recording medium and recognizes this data. This landmark data includes position information about distinctive buildings, mountains, and so forth for reach locale (including a landmark position, longitude data, and latitude data).

The scale setting component 53 sets the scale of a map image on the basis of attribute information. More precisely, the scale setting component sets the scale of a map image on the basis of scene information. Furthermore, the scale setting component sets the scale so as to include the shooting position and the landmark position on the basis of position information included in the landmark information and position information included in the attribute information.

More specifically, the controller 130 sets the scale of a map image on the basis of scene information (including mode data) and GPS position information (including longitude data and latitude data). Even more specifically, the controller 130 sets the scale to a reference scale when the shooting scene is a close-up view, and sets the scale to be larger than the reference scale when the shooting scene is a distant view. The controller 130 also sets the scale so that the map image includes the shooting position and the landmark position when the distance between the shooting position (which indicates attribute information) and the landmark position (which indicates landmark information) is no more than a specific distance.

The map setting component 54 sets the map image so that shooting position is included in the map image, on the basis of map information (including a map database) recorded to a recording medium (such as the memory card 140 and/or the flash memory 142), or to the buffer memory 124, or to both. Also, the map setting component sets the orientation in which the map image is displayed on the basis of orientation information. More specifically, the controller 130 sets the map image (map image data) so that the shooting position is included in the map image on the basis of the map database. Also, the image processor 122 sets the orientation in which the map image is displayed on the basis of orientation data, according to a command from the controller 130. Thus, the processing of the map setting component is performed by the controller 130 and the image processor 122, but is assigned to the image processor 122 in FIG. 3.

In this embodiment, the shooting position is set to the center of the map image, that is, the center of the liquid crystal monitor 123. However, the shooting position does not necessarily have to be the center of the map image, and the configuration may allow this position to be varied as desired.

The map display component 55 displays a map image including the shooting position, in the above-mentioned scale, on the basis of map image data. The map display component also displays the shooting position on the map image. The map display component displays the map image including the shooting position, in the above-mentioned scale and orientation, on the basis of map image data. More specifically, upon receiving a command from the controller 130 and map image data from the image processor 122, the liquid crystal monitor 123 displays the map image including the shooting position, in the above-mentioned scale and orientation.

### 3. Operation of Digital Camera

3-1. Operation During Imaging

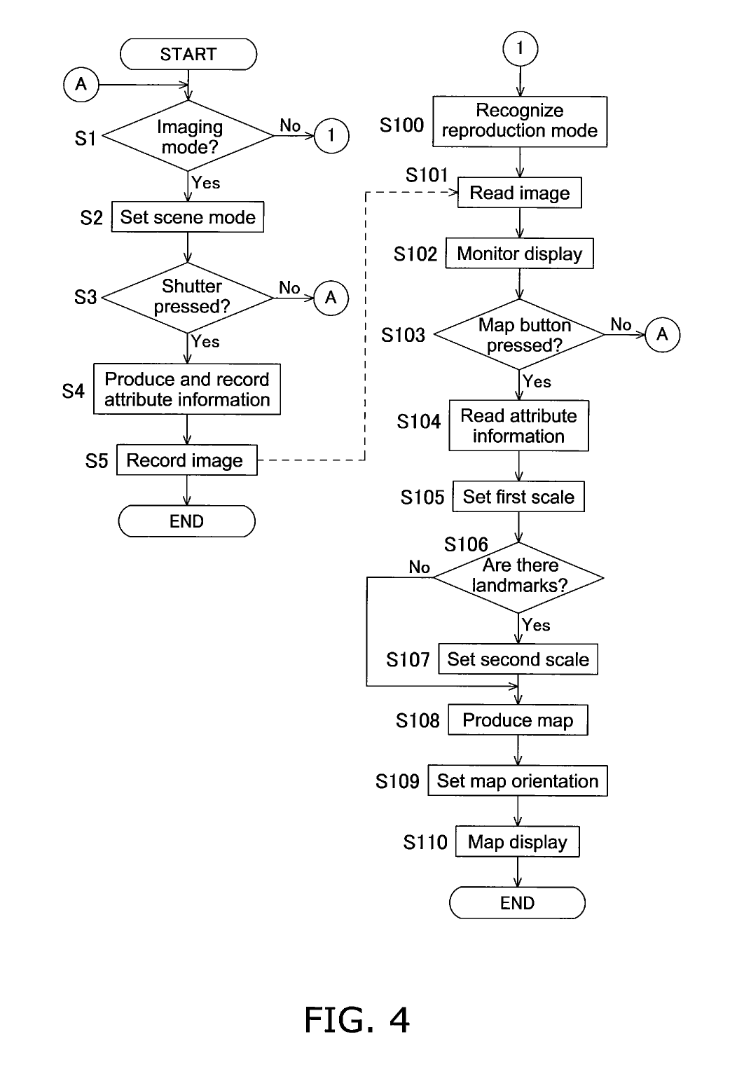

The control of imaging performed by the digital camera 100 will be described. FIG. 4 is a flowchart of imaging control when the digital camera 100 is in imaging mode. The digital camera 100 captures still pictures and moving pictures in imaging mode.

The controller 130 monitors the state of the mode switch 207 (step 1). If the controller 130 detects that the mode switch 207 has been set to imaging mode (Yes in step 1), the controller 130 switches the operation of the entire digital camera 100 to imaging mode operation.

In imaging mode, the controller 130 first performs the initialization processing needed to record still pictures and to record moving pictures. The controller 130 then repeatedly executes user input recognition processing, display processing, and so forth. User input recognition processing, display processing, and so forth include checking the state of the mode switch 207, monitoring the pressing of the set button 204, displaying through-images, monitoring the pressing of the shutter button 201, and so on.

Here, the controller 130 sets the scene mode, for example (step 2). A plurality of scene modes are readied for imaging mode. If the user selects the desired scene mode by touch in a state in which a plurality of scene mode categories are displayed on the liquid crystal monitor 123, the controller 130 sets the selected category of scene mode as the imaging mode.

When the state of the mode switch 207 is switched to reproduction mode during imaging mode, the controller 130 ends the processing of imaging mode (No in step 1).

The plurality of scene modes include, for example, landscape mode, portrait mode, night view mode, night view mode with shake correction, backlight mode, and automatic scene determination mode. Portrait mode is a mode that is suited to capturing an image in which a person's skin will have the proper coloration. Night view mode with shake correction (hand-held night view mode) is a mode that is suited to capturing an image in a state of low surrounding light (in an environment of low illumination), without using a tripod or other stabilizing device for the digital camera 100. Backlight mode is a mode that is suited to capturing an image in an environment with a large difference between bright and dark. Backlight mode is an example of a mode in which sequential capture and combination processing is performed.

When automatic scene determination mode has been selected, one mode from among landscape mode, portrait mode, night view mode, hand-held night view mode, and backlight mode is automatically set on the basis of image data.

The controller 130 also monitors whether or not the shutter 114 has been pressed (step 3). If the controller 130 detects the pressing of the shutter 114 (Yes in step 3), the controller 130 produces attribute information, and this attribute information is recorded to a recording medium such as the memory card 140 and/or the flash memory 142 (step 4).

As long as the controller 130 does not detect the pressing of the shutter button 201 (No in step 3), it continues to monitor whether or not the shutter button 201 has been pressed.

The controller 130 also assigns attribute information to a still picture produced by the image processor 122 on the basis of image information produced by the CCD image sensor 120. The controller 130 then records this still picture having attribute information to a recording medium such as the memory card 140 and/or the flash memory 142 (step 5).

Similarly, the controller 130 monitors whether or not the moving picture capture button 210 has been pressed (step 3). If the controller 130 detects the pressing of the moving picture capture button 210 (Yes in step 3), the controller 130 produces attribute information, and records this attribute information to a recording medium such as the memory card 140 and/or the flash memory 142 (step 4).

As long as the controller 130 does not detect the pressing of the moving picture capture button 210 (No in step 3), it continues to monitor whether or not the moving picture capture button 210 has been pressed.

The controller 130 also successively records image information produced by the image processor 122 on the basis of the image information produced by the CCD image sensor 120, as a moving picture to a recording medium such as the memory card 140 or the flash memory 142. Here, just as with a still picture, attribute information is assigned to the moving picture. The controller 130 then records this moving picture having attribute information to a recording medium such as the memory card 140 and/or the flash memory 142 (step 5). In the case of a moving picture, the recording of the moving picture ends when the moving picture capture button 210 is pressed again.

The attribute information includes mode data for specifying the scene mode, GPS longitude data and latitude data acquired by the GPS 127, orientation data acquired by the orientation sensor 128, and landmark longitude data and latitude data included in the landmark position information. This data is recorded to the recording media 140 and 142 and/or the buffer memory 124. The controller 130 refers to this data as needed. GPS information may also include date data.

3-2. Operation During Map Reproduction

The map reproduction control of the digital camera 100 will be described. FIG. 4 is a flowchart of map reproduction control when the digital camera 100 is in reproduction mode.

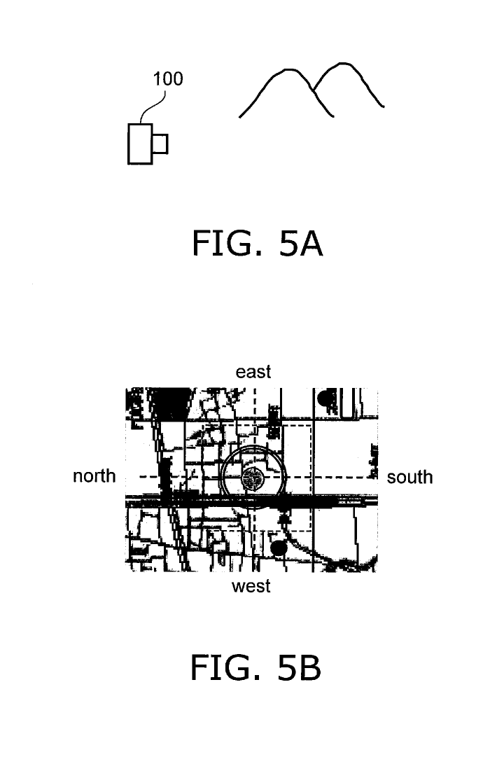

FIGS. 5A, 6A, and 7A are schematic diagrams of a shooting situation with a digital camera. FIGS. 5B, 6B, and 7B are diagrams of a map image displayed on a liquid crystal monitor of a digital camera.

The digital camera 100 is able to reproduce maps in reproduction mode. The map data used for reproducing a map is recorded to the memory card 140 and/or the flash memory 142. Landmark information is also recorded to the memory card 140 and/or the flash memory 142.

The controller 130 switches the operation of the entire digital camera 100 to reproduction mode when it is detected that the mode switch 207 has been set to reproduction mode (No in step 1).

In reproduction mode, the controller 130 first performs initialization processing necessary for reproduction of still pictures and reproduction of moving pictures. The controller 130 then repeatedly executes user input recognition processing, display processing, and so forth. User input recognition processing, display processing, and so forth include checking the state of the mode switch 207, monitoring the pressing of the set button, monitoring the pressing of the map button, displaying reproduced images, monitoring the state of the zoom lever 202, monitoring the state of a scale lever 209, and so forth.

In reproduction mode, the controller 130 reads a still picture and/or moving picture recorded to the memory card 140 and/or the flash memory 142, and recognizes the picture (step 101). The controller 130 then issues an image display command, and the liquid crystal monitor 123 displays the still picture and/or moving picture (step 102).

During reproduction mode, if the state of the mode switch 207 is switched to imaging mode, the controller 130 ends the processing of reproduction mode. In this event, the controller 130 executes the processing of step 1.

The controller 130 also monitors the pressing state of the map button 206 (step 103). If the controller 130 detects that the map button 206 has been pressed (Yes in step 103), the controller 130 reads attribute information from the still picture and moving picture being reproduced at the point when the map button 206 was pressed, and recognizes these pictures (step 104). More specifically, the controller 130 reads and recognizes GPS longitude data, latitude data, and mode data.

If the controller 130 recognizes mode data here, the controller 130 reads table information giving the correlation between scale and the scene mode (imaging mode) corresponding to the mode data, from the recording media 140 and 142 and/or the buffer memory 124, and recognizes this information. The controller 130 then searches for scale data corresponding to the scene mode on the basis of this table information, and sets this scale data as a first scale of the map image (step 105).

More specifically, with table information, when the scene is a close-up view, the first scale is set to be smaller than the reference scale, and when the scene is a distant view, the first scale is set to be larger than the reference scale. Even more specifically, in portrait mode, the first scale is set to be smaller than the reference scale in the table information. In landscape mode and night view mode, the first scale is set to be larger than the reference scale in the table information. The reference scale is set to a specific value.

The table information may be stored as ROM information in a program, or may be stored as separate data in the recording media 140 and 142.

The controller 130 then decides whether or not there is a landmark near the shooting position (the position of the camera) (step 6). More precisely, the controller 130 decides whether or not there is a landmark near the shooting position (the position of the camera) on the basis of GPS latitude data and longitude data. More specifically, the controller 130 decides whether or not the distance between two points, namely, between the shooting position indicated by the GPS latitude data and longitude data and the landmark position indicated by the landmark latitude data and longitude data, is less than or equal to a specific distance.

If this distance between two points is less than or equal to a specific distance (Yes in step 107), the controller 130 decides that there is a landmark near the shooting position (the position of the camera). The controller 130 then sets a second scale so that the shooting position and the landmark position are included in the map image (step 107). More specifically, the second scale of the map image is set so that the shooting position and the landmark position fall within the range of the liquid crystal monitor 123.

Even more specifically, table information indicating the correlation between scale and the distance between two points is recorded to the recording media 140 and 142. The controller 130 then searches for scale data corresponding to the distance between two points, and sets this scale data as the second scale of the map image. The table information here may be stored as ROM information in a program, or may be stored as separate data in the recording media 140 and 142.

Then, the image processor 122 produces reproduction-use map image data by using the scale data for the second scale, on the basis of an image formation command from the controller 130 (step 108). If the above-mentioned distance between two points is greater than a specific distance (No in step 106), the controller 130 decides that there is no landmark near the shooting position (the position of the camera). In this case, the image processor 122 uses the scale data for the first scale to produce reproduction-use map image data (step 108).

The controller 130 then sets the orientation for reproducing the reproduction-use map image (step 109). More specifically, the controller 130 sets the orientation reproducing the reproduction-use map image on the basis of orientation data. The image processor 122 then rotates the map image data according to the orientation indicated by the orientation data. Even more specifically, the image processor 122 rotates the map image data so that the upper side of the liquid crystal monitor 123 will be the orientation indicated by the orientation data.

Whether or not to use the orientation information during reproduction of a map image can be decided by the user, switching this on or off by menu setting or the like. In default, the reproduction of a map is set so that the upper side of the liquid crystal monitor 123 is the north side on the map.

The liquid crystal monitor 123 then displays a map image on the basis of map image data produced from orientation data and scale data for the first scale or scale data for the second scale. More specifically, when a map display command is issued by the controller 130, the map image data is sent from the image processor 122 to the liquid crystal monitor 123, and the map image is displayed on the liquid crystal monitor 123.

More specifically, when an image is captured in landscape mode as shown in FIG. 5A, the liquid crystal monitor 123 displays a map image that takes into account landscape mode and landmark information, as shown in FIG. 5B. With the map image in FIG. 5B, the orientation at which the subject image was captured is also taken into account. For example, as shown in FIG. 5A, if the orientation at which the subject image was captured is to the east, then the liquid crystal monitor 123 displays a map image so that the east in the map image is located at the top of the liquid crystal monitor 123.

The map image includes a pointer that indicates the shooting position (an open circle in FIG. 5B), and the user can use this pointer to quickly find the shooting position. The map image also includes pointers that indicate landmark positions (a filled circle in FIG. 5B), and the user can use these pointers to quickly find landmark positions.

### 4. Conclusion

(4-1) This digital camera 100 comprises an image recognition component, an attribute recognition component, a scale setting component, a map setting component, and a map display component. The image recognition component recognizes image data displayed on the display component 123. The attribute recognition component recognizes attribute information, which is information related to a shooting situation, and is associated with image data (such as the imaging mode (scene mode), the shooting position of the camera, the orientation, and the position of landmarks). The scale setting component sets a first scale (or a second scale) for a map image on the basis of attribute information, such as the imaging mode and the shooting position of the camera. The map setting component sets a map image so that the shooting position had by the attribute information (such as the shooting position of the camera) is included in the map image, on the basis of a map database stored in the recording media 140 and 142. The map display component displays a map image including the shooting position, in the first scale or second scale.

With this digital camera 100, the first scale (or second scale) of a map image is set on the basis of attribute information, such as the imaging mode and the shooting position of the camera. Also, a map image including the shooting position had by the attribute information (such as the shooting position of the camera) is displayed on the liquid crystal monitor 123.

Consequently, the map image can be displayed on the liquid crystal monitor 123 in the optimal scale according to the imaging mode (scene mode), so the user can spot the desired information, such as the shooting position of the camera on the map image, while having to change the scale of the map image displayed on the liquid crystal monitor 123. Specifically, the user can spot the desired information without performing any operation to change the scale of the map. Thus, with this digital camera 100, the user can acquire position information more easily.

(4-2) With this digital camera 100, the map display component displays a pointer that indicates the shooting position on the map image. Thus, the user can be apprised of the shooting position by displaying a pointer on the map image. In other words, the user can easily spot the shooting position.

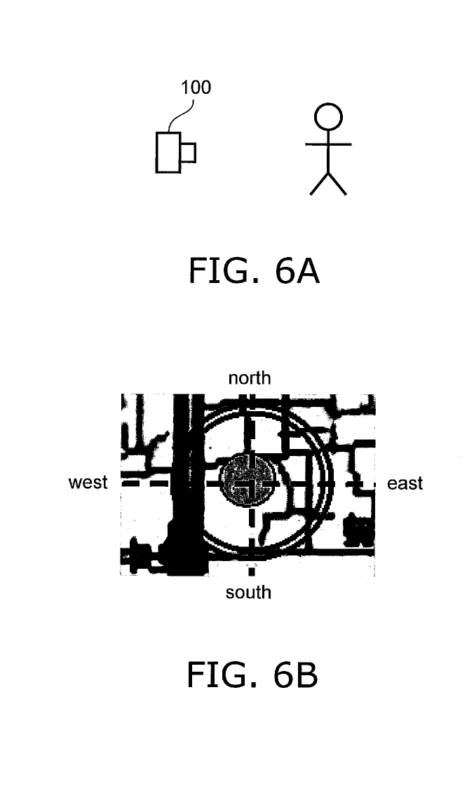

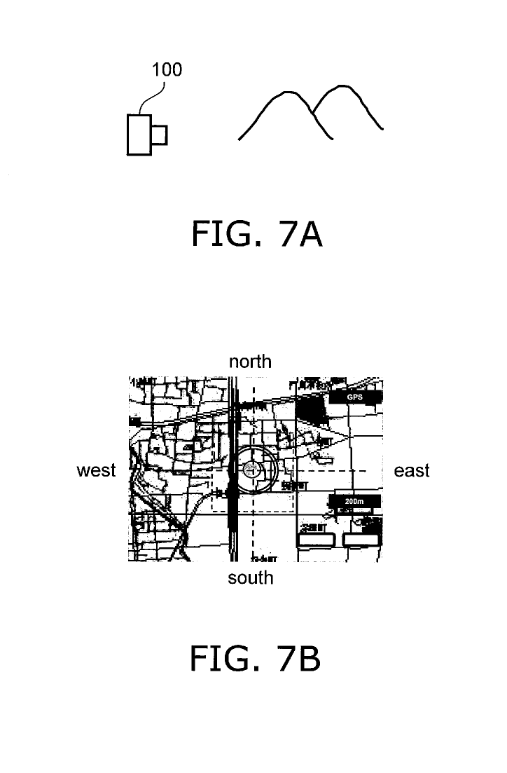

(4-3) With this digital camera 100, the attribute information has scene information (mode data). The scale setting component sets a first scale so that this first scale varies according to the scene information. For example, when the scene is a close-up view, the first scale is set to be smaller than the reference scale, and when the scene is a distant view, the first scale is set to be larger than the reference scale. Consequently, when a person is the subject (see FIG. 6A), the first scale is set to be smaller than the reference scale, so the user can easily spot the shooting position on a map image with a narrow range (see FIG. 6B). Meanwhile, when capturing a night view (see FIG. 7A), the second scale is set to be larger than the reference scale, so the user can easily spot the shooting position on a map image with a wide range (see FIG. 7B). Accordingly, the user can easily spot the shooting position without performing any operation to change the scale of the map.

(4-4) With this digital camera 100, the attribute information has bearing information, which is information related to the bearing of the imaging. The map setting component sets the orientation in which the map image is displayed on the basis of this bearing information. The map display component uses the above-mentioned first scale or second scale to display a map image including the shooting position on the liquid crystal monitor 123 in the above-mentioned orientation.

In this case, the map image can be displayed on the liquid crystal monitor 123 by varying the orientation of the map image according to the direction in which the subject image was captured by the digital camera 100. For example, the map image can be displayed on the liquid crystal monitor 123 so that the direction in which the subject image was captured is always at the top of the liquid crystal monitor 123. Consequently, the user can more easily spot the shooting position within the map image. Accordingly, the user can easily spot the shooting position without performing any operation to change the scale of the map.

(4-5) With this digital camera 100, the landmark information recognition component recognizes landmark information, which is information related to landmark positions and stored in a memory component. The scale setting component sets the second scale so as to include the shooting position and landmark positions, on the basis of attribute information and landmark information.

In this case, since a map image including the shooting position and landmark positions is displayed on the liquid crystal monitor 123, the user can easily spot the shooting position, and can easily imagine the surrounding situation at the time of imaging from the landmark positions. Accordingly, the user can easily spot the shooting position without performing any operation to change the scale of the map.

(4-6) With this digital camera 100, the scale setting component sets the second scale so as to include the shooting position and landmark positions when the distance between the shooting position indicated by the attribute information and the landmark positions indicated by the landmark information is less than or equal to a specific distance.

In this case, a map image including the shooting position and landmark positions can be displayed on the liquid crystal monitor 123 only when there are landmarks near the shooting position. In other words, if the landmarks are so far away from the shooting position that they make little impression on the user, then those landmarks can be eliminated from the map image. Consequently, the landmark positions are suitably disposed and displayed in the map image, so the user can easily spot the shooting position.

### Other Embodiments

(A) In the above embodiment, a second scale was used to reproduce a map, but as shown in FIGS. 6 and 7, a map may be reproduced using just a first scale, without using any second scale.

(B) In the above embodiment, the orientation of the map could be changed, but as shown in FIGS. 6 and 7, the map may be reproduced without taking the orientation of the map into account.

(C) In the above embodiment, an example was given in which the GPS information had longitude data and latitude data, but the GPS information may have altitude information. In this case, when a relief map is used as the map image, the shooting position of the camera can be displayed on the relief image. The positions of landmarks can also be displayed on the relief map.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the electronic device. Accordingly, these terms, as utilized to describe the present technology should be interpreted relative to the electronic device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technologies are provided for illustration only, and not for the purpose of limiting the technology as defined by the appended claims and their equivalents.

### INDUSTRIAL APPLICABILITY

The present technology can be widely utilized in electronic devices.

What is claimed is:

1. An electronic device comprising:
an image recognition component configured to recognize image data displayed on a display component;
an attribute recognition component configured to recognize attribute information, the attribute information being information related to a shooting situation and being associated with the image data recognized by the image recognition component;
a scale setting component configured to set a scale of a map image on a basis of the attribute information recognized by the attribute recognition component;
a map setting component configured to set the map image so that the map image includes a shooting position on a basis of map information recorded on a storage component, the attribute information including the shooting position;
a map display component configured to display the map image including the shooting position according to the scale set by the scale setting component.

2. The electronic device according to claim 1, wherein
the map display component indicates the shooting position on the displayed map image.

3. The electronic device according to claim 1, wherein
the attribute information further includes scene information which is information related to a shooting scene, and
the scale setting component, on a basis of the scene information, sets the scale to be smaller than a reference scale if the shooting scene is a close-up, and sets the scale to be larger than the reference scale if the shooting scene is a distant view.

4. The electronic device according to claim 1, wherein
the attribute information further includes orientation information which is information related to an orientation of imaging,
the map setting component sets a direction in which the map image is displayed, on the basis of the orientation information, and
the map display component displays the map image including the shooting position according to the scale set by the scale setting component and the direction set by the map setting component.

5. The electronic device according to claim 1, further comprising:
a landmark information recognition component configured to recognize landmark information, the landmark information being information related to a landmark position, wherein
the scale setting component sets the scale so that the map image includes the shooting position and the landmark position, on the basis of the attribute information recognized by the attribute recognition component and the landmark information recognized by the landmark information recognition component.

6. The electronic device according to claim 5, wherein
the scale setting component sets the scale so that the map image includes the shooting position and the landmark position if a distance between the shooting position indicated by the attribute information and the landmark position indicated by the landmark information is no greater than a specific distance.
